(19) United States
(12) Patent Application Publication
(10) Pub. No.: US 2012/0185240 A1
(43) Pub. Date: Jul. 19, 2012

(54) SYSTEM AND METHOD FOR GENERATING AND SENDING A SIMPLIFIED MESSAGE USING SPEECH RECOGNITION

(76) Inventors: Michael D. Goller, Cincinnati, OH (US); Stuart E. Goller, Cincinnati, OH (US)

(21) Appl. No.: 13/350,040

(22) Filed: Jan. 13, 2012

Related U.S. Application Data
(60) Provisional application No. 61/433,263, filed on Jan. 17, 2011.

(51) Int. Cl. G10L 15/26

(52) U.S. Cl. 704/201; 704/E15.043

(57) ABSTRACT

An embodiment provides a system and method for generating and sending a simplified message using speech recognition. The system provides a speech recognition software that may be utilized for receiving audio, converting audio to text derived from audio, comparing text derived from audio to match fields to find matches, replacing matched text with contents of replacement fields associated to the match fields, generating an output message incorporating the replacement text into the text derived from audio, transmitting the output message to a messaging system and redistributing the output message to recipients.

### PRIORITY

This application claims priority to U.S. Provisional Patent Application Ser. No. 61/433,263, filed Jan. 17, 2011, entitled “SYSTEM AND METHOD FOR GENERATING AND SENDING A SIMPLIFIED MESSAGE USING SPEECH RECOGNITION,” the disclosure of which is incorporated by reference herein.

### FIELD OF INVENTION

The present invention relates generally to the field of generating and sending a simplified message with the use of speech recognition, and more specifically with generating a message by way of speech recognition, processing the message to identify and replace parts of the message in a way to simplify the message, then send the simplified message.

### BACKGROUND OF THE INVENTION

Speech recognition systems, i.e. systems for recognizing spoken language, are rapidly increasing in significance in many areas of data and communications technology. Speech recognition systems typically are comprised of a computing system loaded with a speech recognition software for processing. Many speech recognition software have a grammar, sometimes also called a dictionary, either built in or in some other way available to the software.

Speech recognition software can be constructed for installation and use in servers, in client devices, as applications in computing devices, in web applications, desktop application, mobile applications, and in some browsers.

Speech recognition software designed for use in servers, in client devices, computing devices, web applications, desktop applications, mobile applications, and some browsers are currently available from companies such as Tazti by Voice Tech Group, Inc., IBM, Nuance, Phillips, Loquendo, Opera and Microsoft as well as others. Some suppliers manufacture speech recognition software specifically for cell phone, GPS, game systems, PC's, and PDA platform applications.

Speech recognition software are currently used in many applications such as interactive voice response systems, command recognition systems giving direction to a server or computing device, dictation mode systems including medical transcription, speaker identification, speech analytics, keyword processing, automotive applications, and hypertext navigation including multi-modal navigation. Speech recognition software can interact with many applications and systems that do not include a speech recognition capability. Some applications a speech recognition software may interact with include computer games, cell phone games, spreadsheets, word processors, presentation software such as Powerpoint, productivity applications like Photoshop, robotics applications, artificial intelligence applications, natural language processing applications, mobile applications, web applications, web services, email, SMS messaging, MMS messaging, cell phone applications, desktop applications, server applications, operating system, client applications and applications that have API's and API's that allow parameters to be passed to them. The interaction may encompass anywhere from complete control of an application via speech recognition to limited interactions.

In each of the applications and platforms listed above a grammar may be required. The grammar may be in one of many different forms such as a database, XML file, other file type, dynamic data, or other data form, accessible by a speech recognition software. Most grammars are generally not accessible by speech recognition software other than those they were designed to operate with. A grammar may be designed specifically to interact with one or more particular applications external to a speech recognition software. A grammar may have many words in it or just a few words depending on the application it is being used for. Some existing speech recognition software currently allows a user to modify a grammar allowing the user to create custom speech commands not normally in a grammar.

Currently messaging systems such as SMS and MMS allow a user to generate messages of a restricted character length and then send those messages to a delivery address assigned by the user or an automated system. Some speech recognition software have a dictation feature that may be used to generate a text. The text may be of a restricted character length. The text may be used to generate a message.

As an example, there may be a clear benefit if a user can generate a message of a character length longer than allowed in a message transmission system, then process the message to simplify the message by substituting words and characters with one or more other characters, words, phrases, sentences, paragraphs, documents, symbols, glyphs, acronyms, abbreviations, emoticons, URL's or numbers with a short enough character count to have transformed the message such that it now is within the character limit for its system and can successfully be transmitted to it's assigned delivery location.

The simplified message's meaning may be discern-able to the message recipient.

### SUMMARY OF THE INVENTION

A system and method for generating and sending a simplified message.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary network in which a system and a method, consistent with the present invention may be implemented;

FIG. 2 illustrates an exemplary computing device

FIG. 3 illustrates an exemplary messaging system

FIG. 4 illustrates an exemplary computing device with a speech recognition software, and a list of matches and replacements;

FIG. 5 illustrates an exemplary computing device with a speech recognition software, a list of matches and replacements, match fields and associated replacement fields;

FIG. 6 illustrates an exemplary computing device communicating with a messaging system;

FIG. 7 illustrates exemplary process steps for generating a shortened message using speech recognition and transmitting it.

### DETAILED DESCRIPTION

The present invention described below illustrates a system and method for generating and sending a simplified message. The following detailed description of the invention refers to the accompanying drawings. The same reference numbers in different drawings identify the same or similar elements. In the following description numerous specific details are set forth in order to provide a more thorough understanding of the present invention. It will be apparent, however, to one skilled in the art, that the present invention may be practiced without these specific details. In other instances, well-known features have not been described in detail so as not to obscure the invention. Also the following detailed description does not limit the invention. Instead, the scope of the invention is defined by the appended claims.

Exemplary Network

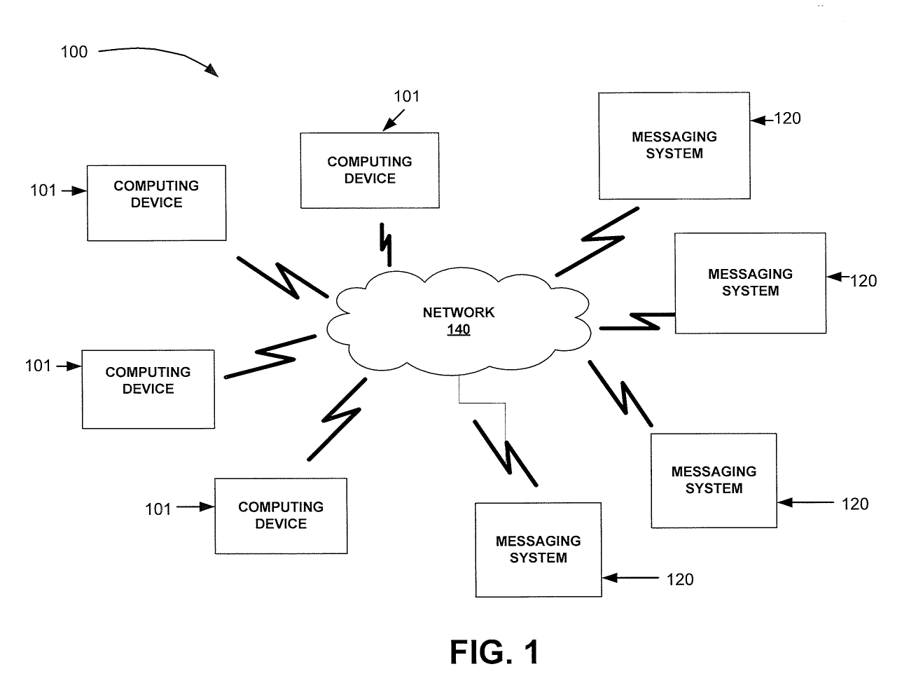

FIG. 1 illustrates an exemplary network 100 in which a system and method, consistent with the present invention, may be implemented. The network 100 may include multiple computing devices 101 connected to one or more messaging systems 120 or computing devices 101 via a network 140. The network 140 may include a local area network (LAN), a wide area network (WAN), a telephone network such as the Public Switched Telephone Network (PSTN), a wireless network, a optical network, a cellular network, an intranet, Internet, cloud, data network, satellite network, other network, or a combination of networks. Four computing devices 101 and four messaging systems 120 have been illustrated as connected to network 140 for simplicity. In practice, there may be more or less computing devices 101 and messaging systems 120. Also, in some instances, a messaging system 120 may perform the functions of a computing device 101 and a computing device 101 may perform the functions of a messaging system 120. Also, in some instances, network 140 may perform the functions of a computing device 101 and a computing device 101 may perform the functions of a network 140. Also, in some instances, network 140 may perform the functions of a messaging system 120 and a messaging system 120 may perform the functions of a network 140.

The computing device 101 may include devices, such as computers, mainframes, minicomputers, personal computers, laptops, tablets, personal digital assistants, telephones, console gaming devices, mobile gaming devices, set top boxes, TV, home appliance, cell phones or the like, capable of connecting to the network 140. The computing device 101 may have a means for input, and may have a means for output. The computing device 101 may transmit data over the network 140 or receive data from the network 140 via a wired, wireless, audio, optical or other connection. In some instances, the computing device 101 may process one or more of information, data, signals, audio, images, spreadsheet, database, XML file, other file type, text, characters, words, phrases, sentences, paragraphs, documents, symbols, glyphs, pictographs, pictograms, acronyms, abbreviations, emoticons, numbers, speech commands, grammar, dictionary, thesaurus, one or more languages, synonyms, antonyms and URL's. In alternative implementations, the computing device 101 may comprise mechanisms for directly connecting to one or more messaging system 120.

The messaging system 120 may include one or more types of computer systems, such as a mainframe, minicomputer, or personal computer, laptops, tablets, personal digital assistants, telephones, console gaming devices, mobile gaming devices, set top boxes, TV, home appliance, cell phones or the like capable of connecting to the network 140 to enable messaging system 120 to communicate with a computing device 101. The messaging system 120 may have a means for input, and may have a means for output. In some instances, the messaging system 120 may process one or more of information, data, signals, audio, images, spreadsheet, database, XML file, other file type, text, characters, words, phrases, sentences, paragraphs, documents, symbols, glyphs, pictographs, pictograms, acronyms, abbreviations, emoticons, numbers, speech commands, grammar, dictionary, thesaurus, one or more languages, synonyms, antonyms and URL's. A messaging system 120 may comprise a website, web service, SMS service, MMS service, chat, instant messaging, social network website, forum website, mobile website, mobile application, email service, game, online game, TV service; satellite, wireless, optical, telephone, cellular, cable, internet or other network. The messaging system 120 may transmit data over network 140 or receive data from the network 140 via a wired, wireless, audio, satellite, optical or other connection. In alternative implementations, the messaging system 120 may comprise mechanisms for directly connecting to one or more computing devices 101 such as a phone bump service or peer to peer technology or other file sharing system.

Exemplary Computing Device

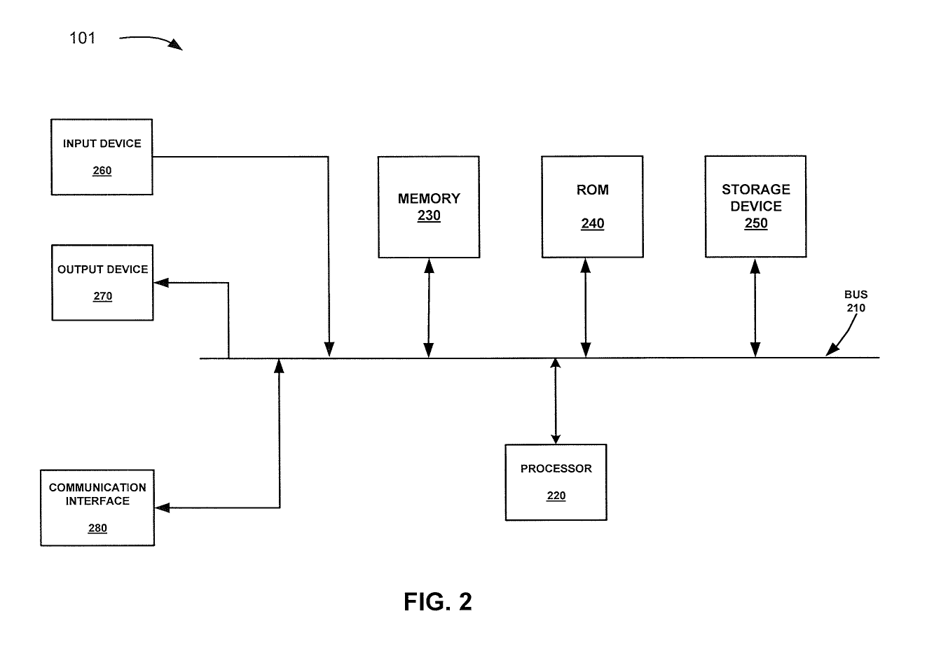

FIG. 2 illustrates an exemplary computing device 101 consistent with the present invention. The computing device 101 may include a bus 210, a processor 220, a main memory 230, a read only memory (ROM) 240, a storage device 250, an input device 260, an output device 270, and a communication interface 280. The bus 210 may include one or more conventional buses that permit communication among the components of the computing device 101.

Computing device 101 may be a client device. Computing device 101 may be a server.

The processor 220 may include any type of conventional processor or microprocessor that interprets and executes instructions. The main memory 230 may include a random access memory (RAM), static memory or another type of storage device that stores information and instructions for execution by the processor 220. The ROM 240 may include a conventional ROM device or another type of static storage device that stores static information and instructions for use by the processor 220. The storage device 250 may include a solid state drive, static storage device, magnetic and/or optical recording medium and its corresponding drive.

The input device 260 may include one or more conventional mechanisms that permit a user to input information to the client device 101, such as a keyboard, a mouse, a pen, gesture recognition device, thought recognition device, biometric recognition device, a microphone, other mechanisms, etc. The output device 270 may include one or more conventional mechanisms that output information to the user, including a display, a printer, a speaker, etc. The communication interface 280 may include any transceiver-like mechanism that enables the computing device 101 to communicate with other devices and/or systems. For example, the communication interface 280 may include mechanisms for communicating with another device or system via a network, such as network 140.

As will be described in detail below, a computing device 101, consistent with the present invention, may perform certain inputting, converting, comparing, identifying, matching and replacing related operations. The computing device 101 may perform these operations in response to processor 220 executing software instructions contained in a computer-readable medium, such as memory 230. A computer-readable medium may be defined as one or more memory 230 and/or carrier waves.

The software instructions may be read into memory 230 from another computer-readable medium, such as the data storage device 250, or from another device via the communication interface 280. The software instructions contained in memory 230 may cause processor 220 to perform the converting, comparing, identifying, matching and replacing related activities described below. Alternatively, hardwired circuitry may be used in place of or in combination with software instructions to implement processes consistent with the present invention. Thus, the present invention is not limited to any specific combination of hardware circuitry and software.

Exemplary Messaging System

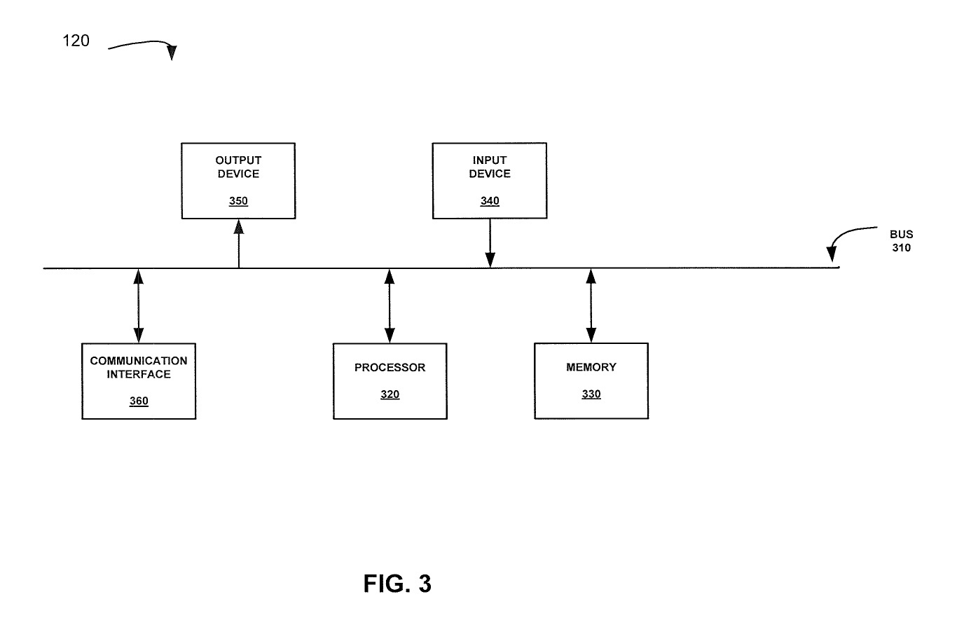

FIG. 3 illustrates an exemplary messaging system 120 consistent with the present invention. The messaging system 120 may include a bus 310, a processor 320, a memory 330, an input device 340, an output device 350, and a communication interface 360. The bus 310 may include one or more conventional buses that allow communication among the components of the messaging system 120.

The processor 320 may include any type of conventional processor or microprocessor that interprets and executes instructions. The memory 330 may include a RAM or another type of dynamic storage device that stores information and instructions for execution by the processor 320; a ROM or another type of static storage device that stores static information and instructions for use by the processor 320; some type of solid state device, magnetic or optical recording medium and its corresponding drive.

The input device 340 may include one or more conventional devices that permit an input of information to the messaging system 120, such as a keyboard, a mouse, a pen, gesture recognition device, thought recognition device, biometric device, a microphone, other mechanisms, and the like. The output device 350 may include one or more conventional devices that outputs information to the operator, including a display, a printer, a speaker, etc. The communication interface 360 may include any transceiver-like mechanism that enables the messaging system 120 to communicate with other devices and/or systems. For example, the communication interface 360 may include mechanisms for communicating with other messaging systems 120 or computing devices 101 via a network, such as network 140.

Messaging system 120 may be a server. Messaging system 120 may be a client device. Messaging system 120 may be in a cloud system. Messaging system 120 may be in a satellite communication system. Messaging system 120 may be in a telephony system. Messaging system 120 may be in a internet.

Execution of the sequences of instructions contained in memory 330 may cause processor 320 to perform the functions described below. In alternative embodiments, hardwired circuitry may be used in place of or in combination with software instructions to implement the present invention. Thus, the present invention is not limited to any specific combination of hardware circuitry and software.

Exemplary Speech Recognition Program

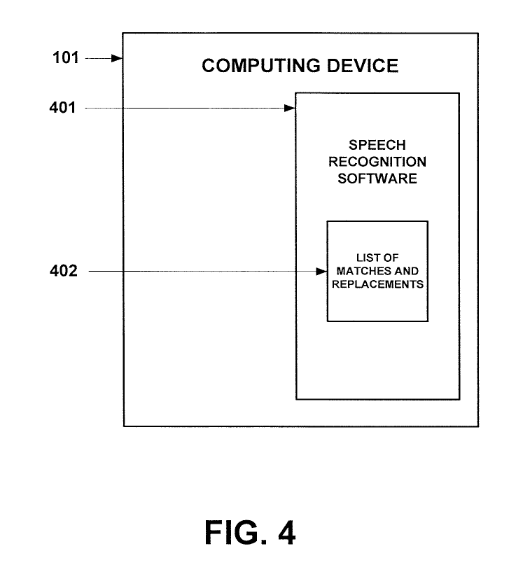

FIG. 4 illustrates a computing device 101, consistent with the present invention, in which a speech recognition software 401 may be loaded into computing device 101. A list of matches and replacements 402, may be loaded in a speech recognition software 401. It will be appreciated, however, that one or more, computing devices 101, or messaging systems 120, may alternatively be loaded with a speech recognition software 401, and may perform the entire process or part of the process described below. One or more speech recognition software 401 may be loaded in a computing device 101. One or more speech recognition software 401 may be loaded in a messaging system 120. One or more speech recognition software 401 may be loaded in a network 140 that may be a cloud network or the like.

Speech recognition software 401 in computing device 101 may have components programmed into it that may be update-able, modify-able, replace-able, or delete-able.

Speech recognition software 401 may comprise a publicly available product such as tazti Speech Recognition, or other speech recognition software and may have a means for input, and may have a means for output. Programming and operation of the “speech to text” component of a speech recognition software 401 is well known to those familiar in the art of speech recognition programming and not discussed in detail here. Speech recognition software 401 may be a custom designed program comprising components other than speech to text processing.

A computer application may comprise a speech recognition software 401. A computer operating system may comprise a speech recognition software 401. A desktop application may comprise a speech recognition software 401. A mobile application may comprise a speech recognition software 401.

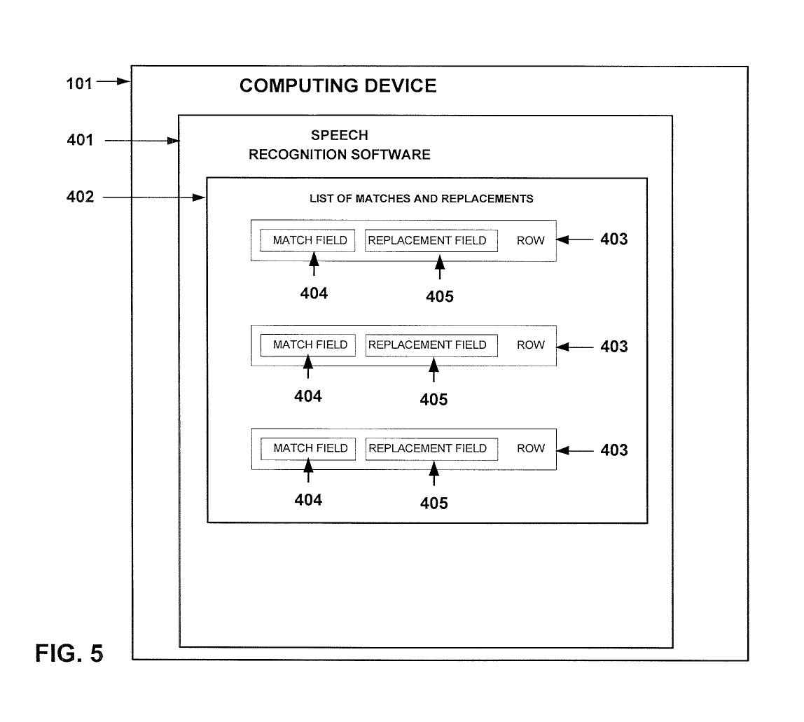

FIG. 5 illustrates a speech recognition software 401 that may be loaded in a computing device 101. Speech recognition software 401 may comprise one or more lists of matches and replacements 402. A list of matches and replacements 402 may comprise one or more rows 403. Each row 403 may comprise one or more match fields 404 and one or more replacement fields 405. A match field 404 may associate to a replacement field 405.

In another implementation of the current invention, one or more match fields 404 and one or more replacement fields 405 may be associated to each other, without the use of rows, via one of many methods of information relationship and information storage well known to those familiar in the art of programming and will not be discussed here. A database may be an example of an information relationship and storage means. Examples of databases may be object oriented, multi dimensional, relational, hierarchical, network, physical, SQL, or other.

The list of matches and replacements 402 may comprise audio, images, spreadsheet, database, XML file, other file type, text, characters, words, phrases, sentences, paragraphs, documents, symbols, glyphs, pictographs, pictograms, acronyms, abbreviations, emoticons, numbers, data, information, signals, speech commands, grammar, dictionary, thesaurus, synonyms, antonyms and URL's. List of matches and replacements 402 may be update-able, modify-able, replace-able, or delete-able.

In another implementation of the current invention, list of matches and replacements 402 may be in a foreign language.

In another implementation of the current invention, list of matches and replacements 402 may be in more than one language.

Row 403 may comprise audio, images, spreadsheet, database, XML file, other file type, text, characters, words, phrases, sentences, paragraphs, documents, symbols, glyphs, pictographs, pictograms, acronyms, abbreviations, emoticons, numbers, data, information, signals, speech commands, grammar, dictionary, thesaurus, synonyms, antonyms and URL's. Row 403 may be update-able, modify-able, replace-able, or delete-able.

In another implementation of the current invention, row 403 may be in a foreign language.

In another implementation of the current invention, row 403 may be in more than one language.

Match field 404 may comprise audio, images, spreadsheet, database, XML file, other file type, text, characters, words, phrases, sentences, paragraphs, documents, symbols, glyphs, pictographs, pictograms, acronyms, abbreviations, emoticons, numbers, data, information, signals, speech commands, grammar, dictionary, thesaurus, synonyms, antonyms and URL's. Match field 404 may be update-able, modify-able, replace-able, or delete-able.

In another implementation of the current invention, match field 404 may be in a foreign language.

In another implementation of the current invention, match field 404 may be in more than one language.

Replacement field 405 may comprise audio, images, spreadsheet, database, XML file, other file type, text, characters, words, phrases, sentences, paragraphs, documents, symbols, glyphs, pictographs, pictograms, acronyms, abbreviations, emoticons, numbers, data, information, signals, speech commands, grammar, dictionary, thesaurus, synonyms, antonyms and URL's. Replacement field 405 may be update-able, modify-able, replace-able, or delete-able.

In another implementation of the current invention, replacement field 405 may be in a foreign language.

In another implementation of the current invention, replacement field 405 may be in more than one language.

In another implementation of the current invention, more than one list of matches and replacements 402 may be available to speech recognition software 401. A user may select which list of matches and replacements 402 to use to compare against text derived from audio.

In another implementation of the current invention, list of matches and replacements 402 containing match fields 404 and replacement fields 405 may be modified at any time by the user.

### Exemplary Message Shortening

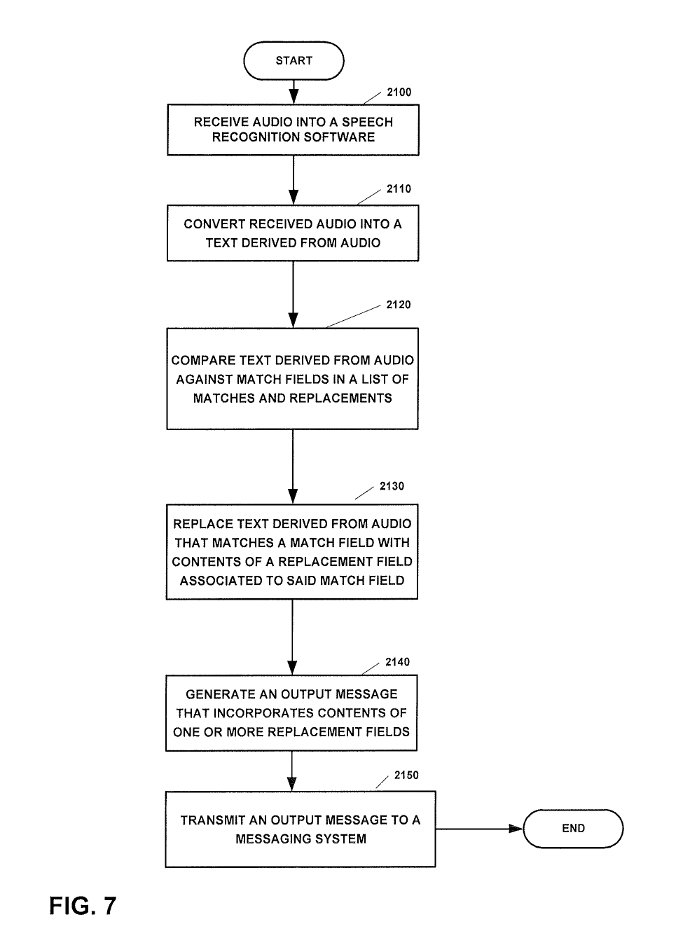

Processing as shown in FIG. 7, may begin with a speech recognition software 401 in a computing device 101 as shown in FIG. 4, receiving [act 2100] audio, from an input device 260 as shown in FIG. 2.

As is know to those familiar with the art, speech recognition software 401 may continue processing by converting [act 2110] input audio into a text derived from audio.

Speech recognition software 401 may compare [act 2120] text derived from audio against one or more match fields 404 in one or more lists of matches and replacements 402 to identify any match fields that match text derived from audio.

Text derived from audio that matches a match field 404, may be replaced [act 2130] with contents of a replacement field 405 associated to said match field 404.

Upon completion of the matching and replacement process, speech recognition software 401 may generate [act 2140] an output message. An output message may comprise audio, images, spreadsheet, database, XML file, other file type, text, characters, words, phrases, sentences, paragraphs, documents, symbols, glyphs, pictographs, pictograms, acronyms, abbreviations, emoticons, numbers, data, information, signals, speech commands, grammar, dictionary, thesaurus, synonyms, antonyms and URL's. A user may be able to set a character length limit on any output message.

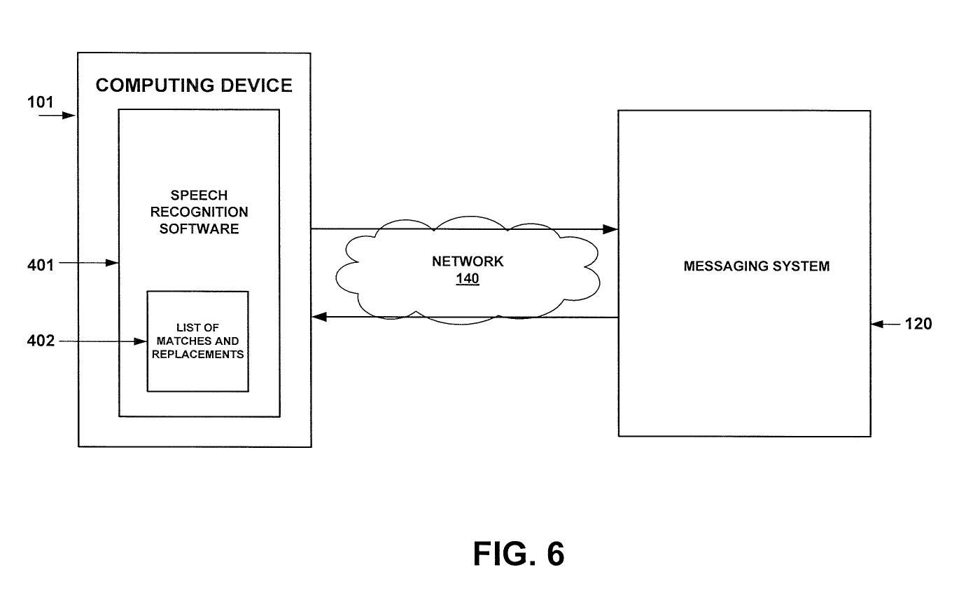

As further illustrated in FIG. 6, a user may transmit [act 2150] an output message from a speech recognition software 401 in a computing device 101 to a messaging system 120 via a network 140. A messaging system 120 may redistribute a output message to none, one or more computing devices 101. A messaging system 120 may redistribute a output message to none, one or more networks 140. A messaging system 120 may redistribute a output message to none, one or more messaging systems 120. A messaging system 120 may redistribute a output message to none, one or more recipients. A messaging system 120 may redistribute an output message to none, one or more other systems for further processing.

In another implementation of the current invention, processing described above may be shared in part or whole between a speech recognition software 401 and one or more other applications.

In another implementation of the current invention, an input device 260 may input non-spoken audio into speech recognition software 401 for processing.

In another implementation of the current invention, a communication interface 280 may input a text into speech recognition software 401 that may process input text in a same method as if it were text derived from audio.

In another implementation of the current invention, speech recognition software 401 may translate text derived from audio into one or more languages before attempting to compare text against match field 404.

In another implementation of the current invention, speech recognition software 401 may translate an output message into one or more foreign languages before transmitting the output message to a messaging system 120, computing device 101, or other system.

In another implementation of the current invention, computing device 101 may save text derived from audio for further processing at a later time.

In another implementation of the current invention, text, characters, words, phrases, sentences, paragraphs, symbols, glyphs, pictographs, pictograms, acronyms, abbreviations, emoticons, numbers, data, information, signals, speech commands, grammar, synonyms, antonyms or URL's may appear more than once in a text derived from audio. Each time text, characters, words, phrases, sentences, paragraphs, symbols, glyphs, pictographs, pictograms, acronyms, abbreviations, emoticons, numbers, data, information, signals, speech commands, grammar, synonyms, antonyms or URL's appear more than once in a text derived from audio it may be compared against match fields 404.

In another implementation of the current invention, a user may have a web browser open when speaking to speech recognition software 401. Speech recognition software 401 may be directed to capture the URL of a webpage, website, web-application, image, or file open in a browser and may forward this URL to a URL shortening service which may return to speech recognition software 401, a short URL acting as an alias to the URL supplied to the service, and which may be appended to or otherwise included in the input audio for speech recognition software 401 to process.

In another implementation of the current invention, a user may have a web browser open when speaking to speech recognition software 401. Speech recognition software 401 may be directed to capture the URL of a webpage, website, web-application, image, or file open in a browser and may forward this URL to a URL shortening service which may return to speech recognition software 401, a short URL acting as an alias to the URL supplied to the service, and which may be appended to or otherwise included in text derived from audio for speech recognition software 401 to process.

In another implementation of the current invention, a user may have a web browser open when speaking to speech recognition software 401. Speech recognition software 401 may be directed to capture the URL of a webpage, website, web-application, image, or file open in a browser and may forward this URL to a URL shortening service which may return to speech recognition software 401, a short URL acting as an alias to the URL supplied to the service, and which may be appended to or otherwise included in an output message generated by speech recognition software 401.

In another implementation of the current invention, a web browser may comprise a speech recognition software 401.

In another implementation of the current invention, a speech recognition software 401 may comprise a web browser.

In another implementation of the current invention an input device 260 may be external to a computing device 101 and may interact with computing device 101. An example of an input device 260 that may interact with computing device 101 is a headset microphone.

In another implementation of the current invention a user may utilize a device to read a person's lips to identify words, sentences, sounds, noise and convert them to a text derived from reading lips which can be input to a speech recognition software 401.

### CONCLUSION

A system and method for generating and sending a simplified message using speech recognition. The system provides a speech recognition software that may be utilized for receiving audio, converting audio to text derived from audio, comparing text derived from audio to match fields to find matches, replacing matched text with contents of replacement fields associated to the match fields, generating an output message incorporating the replacement text into the text derived from audio, transmitting the output message to a messaging system and redistributing the output message to none, one or more recipients.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, it is possible that audio received into a speech recognition software may derive from a source other than a human such as a cat's meow that a speech recognition software can identify and convert to a text representation. Another audio received into a speech recognition software, example, may be computer generated audio simulation of human voices or other sounds that a speech recognition software can identify and convert into a text representation. Comparing, matching, text replacement, output message generation and message transmission to one or more recipients may occur in the above provided examples similarly as described in the body of this document. The order of the acts may be altered in other implementations consistent with the present invention. No element, act, or instruction used in the description of the present application should be construed as critical or essential to the invention unless explicitly described as such.

The scope of the invention is defined by the following claims and their equivalents.

I/We claim:

1. A method of generating a simplified message using speech recognition and transmitting said simplified message, the method comprising;
receiving audio;
converting audio into text derived from audio;
comparing text derived from audio against the contents of one or more match fields of a plurality of match fields in a list of matches and replacements of a plurality of lists of matches and replacements;
replacing text derived from audio that matches the contents of a match field of a plurality of match fields with the contents of a replacement field of a plurality of replacement fields associated to said match field of a plurality of match fields;
generating an output message;
transmitting said output message to a messaging system of a plurality of messaging systems, for delivery to a recipient of a plurality of recipients;
resulting in a simplified message that is transmitted to a recipient of a plurality of recipients.

2. The method of claim 1 wherein;
receiving audio;
converting audio into text derived from audio;
comparing text derived from audio against the contents of one or more match fields of a plurality of match fields in a list of matches and replacements of a plurality of lists of matches and replacements;
replacing text derived from audio that matches the contents of a match field of a plurality of match fields with contents of a replacement field of a plurality of replacement fields associated to said match field of a plurality of match fields;
generating an output message;
transmitting said output message;
is performed by a speech recognition program.

3. The method of claim 1 wherein audio is received into a speech recognition program.

4. The method of claim 1 wherein audio is converted by a speech recognition program into text derived from audio.

5. The method of claim 1 wherein text derived from audio is compared in a speech recognition program for matches against, the contents of one or more match fields of a plurality of match fields in a list of matches and replacements of a plurality of lists of matches and replacements.

6. The method of claim 1 wherein the process of replacing text derived from audio that matches the contents of a match field of a plurality of match fields with the contents of a replacement field of a plurality of replacement fields associated to said match field of a plurality of match fields, occurs in a speech recognition program.

7. The method of claim 1 further comprising a speech recognition program performing all the steps of the invention.

8. The method of claim 1 wherein a speech to text conversion capability is utilized to convert audio into text derived from audio.

9. The method of claim 1 wherein text derived from audio is one or more of information, data, signals, audio, images, spreadsheet, database, XML file, other file type, text, characters, words, phrases, sentences, paragraphs, documents, symbols, glyphs, pictographs, pictograms, acronyms, abbreviations, emoticons, numbers, speech commands, grammar, dictionary, thesaurus, one or more languages, synonyms, antonyms, URLs.

10. The method of claim 1 wherein the contents of said match field is one or more of information, data, signals, audio, images, spreadsheet, database, XML file, other file type, text, characters, words, phrases, sentences, paragraphs, documents, symbols, glyphs, pictographs, pictograms, acronyms, abbreviations, emoticons, numbers, speech commands, grammar, dictionary, thesaurus, one or more languages, synonyms, antonyms, URL's.

11. The method of claim 1 wherein the contents of said replacement field is one or more of information, data, signals, audio, images, spreadsheet, database, XML file, other file type, text, characters, words, phrases, sentences, paragraphs, documents, symbols, glyphs, pictographs, pictograms, acronyms, abbreviations, emoticons, numbers, speech commands, grammar, dictionary, thesaurus, one or more languages, synonyms, antonyms, URL's.

12. The method of claim 1 further comprising a user requesting a URL be submitted to a URL shortening service, later receiving a shortened URL from said URL shortening service, and later integrating said shortened URL into an text derived from audio.

13. The method of claim 1 wherein a desktop application comprises the application.

14. The method of claim 1 wherein the application is a mobile application.

15. The method of claim 1 wherein a operating system comprises the application.

16. The method of claim 1 wherein the application comprises a web browser.

17. The method of claim 1 wherein a web browser comprises the application.

18. The method of claim 1 wherein the application is a plug in for a web browser.

19. The method of claim 1 wherein SMS messaging software comprises the application.

20. The method of claim 1 wherein the application comprises SMS messaging software.

21. The method of claim 1 wherein a MMS messaging software comprises the application.

22. The method of claim 1 wherein the application comprises a MMS messaging software.

23. The method of claim 1 wherein received audio is human speech.

24. The method of claim 1 wherein received audio is other than human speech.

25. The method of claim 1 wherein the application is integrated with another application.

26. A method of generating a simplified message using speech recognition and transmitting said simplified message, the method comprising;
receiving audio;
converting audio into text derived from audio;
comparing text derived from audio against the contents of one or more match fields of a plurality of match fields in a list of matches and replacements of a plurality of lists of matches and replacements;
replacing text derived from audio that matches the contents of a match field of a plurality of match fields with the contents of a replacement field of a plurality of replacement fields associated to said match field of a plurality of match fields;
identifying one or more URLs of a plurality of URLs that could be shortened;
shortening one or more URLs of a plurality of URLs identified for shortening;
integrating any shortened URLs of a plurality of URLs;
generating an output message integrating any shortened URLs of a plurality of URLs;
transmitting said output message to a messaging system of a plurality of messaging systems, for delivery to a recipient of a plurality of recipients;
resulting in a simplified message that is transmitted to a recipient of a plurality of recipients.

27. The method of claim 26 wherein;
receiving audio;
converting audio into text derived from audio;
comparing text derived from audio against the contents of one or more match fields of a plurality of match fields in a list of matches and replacements of a plurality of lists of matches and replacements;
replacing text derived from audio that matches the contents of a match field of a plurality of match fields with the contents of a replacement field of a plurality of replacement fields associated to said match field of a plurality of match fields;
identifying one or more URLs of a plurality of URLs that could be shortened;
shortening one or more URLs of a plurality of URLs identified for shortening;
integrating any shortened URLs of a plurality of URLs generating an output message integrating any shortened URLs of a plurality of URLs;
transmitting said output message to a messaging system of a plurality of messaging systems, for delivery to a recipient of a plurality of recipients;
is performed by a speech recognition program.

28. The method of claim 26 wherein audio is received into a speech recognition program.

29. The method of claim 26 wherein audio is converted by a speech recognition program into text derived from audio.

30. The method of claim 26 wherein the process of replacing text derived from audio that matches the contents of a match field of a plurality of match fields with the contents of a replacement field of a plurality of replacement fields associated to said match field of a plurality of match fields, occurs in a speech recognition program.

31. The method of claim 26 further comprising sending one or more URLs of a plurality of URLs to a URL shortening service of a plurality of URL shortening services and receiving a shortened URL back from said URL shortening service and integrating said shortened URL with text derived from audio.

32. The method of claim 26 wherein the application is integrated with another application.

33. A computing system comprising: a memory configured to store instructions; and a processor configured to execute the instructions to;
receive audio;
convert audio into text derived from audio;
compare text derived from audio against the contents of one or more match fields of a plurality of match fields in a list of matches and replacements of a plurality of lists of matches and replacements;
replace text derived from audio that matches the contents of a match field of a plurality of match fields with the contents of a replacement field of a plurality of replacement fields associated to said match field of a plurality of match fields;
generate an output message;
transmit said output message to a messaging system of a plurality of messaging systems, for delivery to a recipient of a plurality of recipients.

34. The apparatus of claim 33 wherein the computing system is a client device comprising a speech recognition program.

35. The apparatus of claim 33, wherein the computing system is a server comprising a speech recognition program.

36. The apparatus of claim 33, wherein the computing system is a mobile phone or the like.

37. The apparatus of claim 33, wherein the computing system is a set top box.

38. The apparatus of claim 33, wherein the computing system is a personal computer.

39. The apparatus of claim 33, wherein the computing system is a gaming device.

40. The apparatus of claim 33, wherein the computing system is a chat system.

41. The apparatus of claim 33, wherein the computing system is a dictation system.

42. The apparatus of claim 33, wherein the computing system is a SMS messaging system.

43. The apparatus of claim 33, wherein the computing system is a MMS messaging system.

44. The apparatus of claim 33, wherein the computing system is a TV.

45. The apparatus of claim 33, wherein the computing system is a robot.

46. The apparatus of claim 33, wherein the computing system is a multilingual translation device.

47. The apparatus of claim 33, wherein an automobile comprises the computing system.

48. The apparatus of claim 33, wherein the computing system comprises a microphone as an input device.

49. The apparatus of claim 33, wherein the computing system comprises a text input means.

50. The apparatus of claim 33, wherein the computing system interacts with a URL shortening service.
